(19) United States
(12) Patent Application Publication
(10) Pub. No.: US 2009/0243177 A1
(43) Pub. Date: Oct. 1, 2009

(54) LOCATING PIN AND EXTRACTION TOOL

(76) Inventor: David M. Ginburg, Marietta, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/055,441

(22) Filed: Mar. 26, 2008

(51) Int. Cl. B23Q 3/16; B23Q 3/18

(52) U.S. Cl. 269/48; 269/58; 81/488

(57) ABSTRACT

In combination, a locating pin and extraction tool for locating a work piece in conjunction with a jig comprises a locating pin including an elongate body having a head portion and a lower pin portion. The elongate body is of a length which is substantially greater than it is wide, and the pin portion is adapted to be inserted through a locating hole in the jig and into a locating hole in the work piece to locate the work piece. The head portion is a low-profile head, and has a height and width both of which are much smaller than the length of the elongate body. A lifting tool is provided and having a handle and a lifting foot adapted to engage the head portion of the locating pin for lifting and extracting the locating pin.

### TECHNICAL FIELD

The present invention relates generally to devices for securing and locating a work piece during manufacturing to facilitate manufacturing operations, such as machining and drilling, and more particularly relates to a locating pin and extraction tool therefore for removably securing a work piece in a jig or fixture and fixing the location of the work piece relative to the jig or fixture or relative to another work piece.

### BACKGROUND OF THE INVENTION

In manufacturing metal components, it is known to use locating pins for positively locating a work piece in a jig or fixture. For example, FIG. 1 shows some prior art locating pins that are used to locate a work piece relative to a jig or fixture. Each of the locating pins shown in FIG. 1 includes a pin portion P for insertion into a jig or fixture and into the work piece. A handle portion H is provided for inserting and extracting the locating pin. Some of the locating pins include a small hole in one end of the handle H for a retention wire to keep the locating pin secured to the jig or fixture at all times (so the locating pin doesn't get lost or separated). Unfortunately, this style of locating pin, while easy to use, can interfere with certain machining operations due to the large, integral handle extending from the pin portion P. This can make it difficult to machine the work piece close to the locating pin.

Locating pins are also disclosed in some United States Patents. For example, U.S. Pat. No. 4,179,106 of Bergman (and the related U.S. Pat. No. 4,058,885) shows a locating pin with a low-profile head. The locating pin of Bergman is secured in place by a fastener whose broad head extends into a groove formed in the side of the pin. The groove is located below the upper surface of the jig or fixture. In this way, the locating pin is securely positioned and cannot work itself free.

U.S. Pat. No. 4,538,355 of Morghen discloses a locating pin which is threaded (screwed) into place and is held fast against working loose by the provision of a jam nut.

U.S. Pat. No. 4,801,225 of Morghen discloses a locating pin that can be used with different locating bores. The locating pin includes a main pin including an upper portion. The upper portion has apertures for receiving secondary pins.

U.S. Pat. No. 4,500,079 of Morghen discloses a locating pin provided with an intermediate portion and a knurled handle portion. The locating pin is releasably held in place with the use of detent balls, which can be unlocked using a button portion (which can be depressed to allow the detent balls to disengage). The '079 patent also describes that the handle could be T-shaped, instead of being a knurled cylinder.

While the prior art shows the well-known use of locating pins and shows several variations of locating pins for locating a work piece relative to a jig or fixture, a need remains for a locating pin which is low-profile once deployed in order to allow machining near the locating pin. A need also remains for a locating pin which can be easily inserted and then pulled out with a simple extraction tool, all the while providing good clearance for machining nearby. It is to the provision of such a locating pin and extraction tool that the present invention is primarily directed.

### SUMMARY OF THE INVENTION

Briefly described, in a preferred form the present invention comprises, in combination, a locating pin and an extraction tool for locating a work piece in conjunction with a jig. The locating pin includes an elongate body having a head portion and a lower pin portion, the elongate body being of a length which is substantially greater than it is wide. Advantageously, the pin portion is adapted to be inserted through a locating hole in the jig and into a locating hole in the work piece to locate the work piece. The head portion is a low-profile head, and has a height and width both of which are much smaller than the length of the elongate body.

The lifting tool portion of the combination has a handle and a lifting foot adapted to engage the head portion of the locating pin for lifting and extracting the locating pin.

Preferably, the locating pin further comprises a dowel portion extending between the pin portion and the head portion, and the dowel portion has a width which is greater than the width of the pin portion. Moreover, preferably the dowel portion is substantially cylindrical and has a tapered lower edge to facilitate insertion and alignment.

Also preferably, the head portion has a flange that extends transversely beyond an edge of the dowel portion to limit insertion travel of the locating pin. Preferably, the locating pin comprises a generally rounded distal end to avoid scratching or marring the work piece (or work pieces).

In one form, the lifting tool comprises a T-handle and has a crow's foot-shaped lifting foot. Optionally, the locating pin has a groove formed in the side of the low-profile head and the lifting foot includes a U-shaped foot for slipping into and engaging the groove formed in the low-profile head.

Alternatively, the locating pin can include a loop, and the lifting foot can be in the form of a hook for slipping into and engaging the loop in the low-profile head. In another alternative embodiment, the lifting tool can include an offset portion to align the lifting foot with the handle.

The combination of the novel lifting/extraction tool and the novel locating pin provides a very effective device for accurately locating a work piece relative to a jig or fixture or even relative to another work piece, while providing a simple and effective way of extracting the pin from the jig or fixture. The combination manages to accomplish this while providing a low-profile, such that greater clearance is provided for machining operations, such as drilling, milling, surface grinding, etc.

### BRIEF DESCRIPTION OF THE DRAWINGS

FIG. 1 is a perspective illustration of three prior art locating pins.

FIG. 2 is a perspective illustration of a locating pin and extraction tool combination according to a first preferred form of the invention.

FIG. 3 is an elevation view of a locating pin as shown in FIG. 2.

FIG. 4 is a perspective illustration of an extraction tool as shown in FIG. 2.

FIG. 5A is a sectional view showing a locating pin as shown in FIG. 2 inserted through a jig and into a work piece for facilitating a machining operation.

FIG. 5B is a sectional view showing a locating pin as shown in FIG. 2 inserted through a jig and into and through several work pieces for facilitating a machining operation.

FIG. 6 is a perspective view showing a locating pin as shown in FIG. 2 inserted through a jig and into a work piece for facilitating a machining operation.

FIG. 7 is a sectional view showing a locating pin according to another form of the invention and shown inserted through a jig and into a work piece for facilitating a machining operation.

FIG. 8 is a perspective illustration of a locating pin and extraction tool combination according to another preferred form of the invention.

FIG. 9 is an elevation view of a locating pin and extraction tool combination according to another preferred form of the invention.

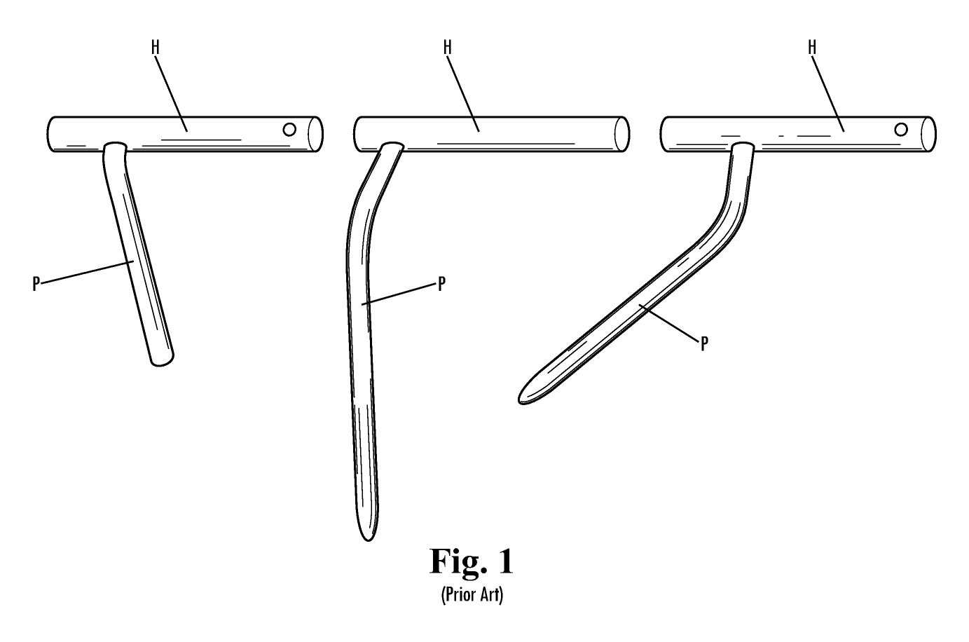

### DETAILED DESCRIPTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

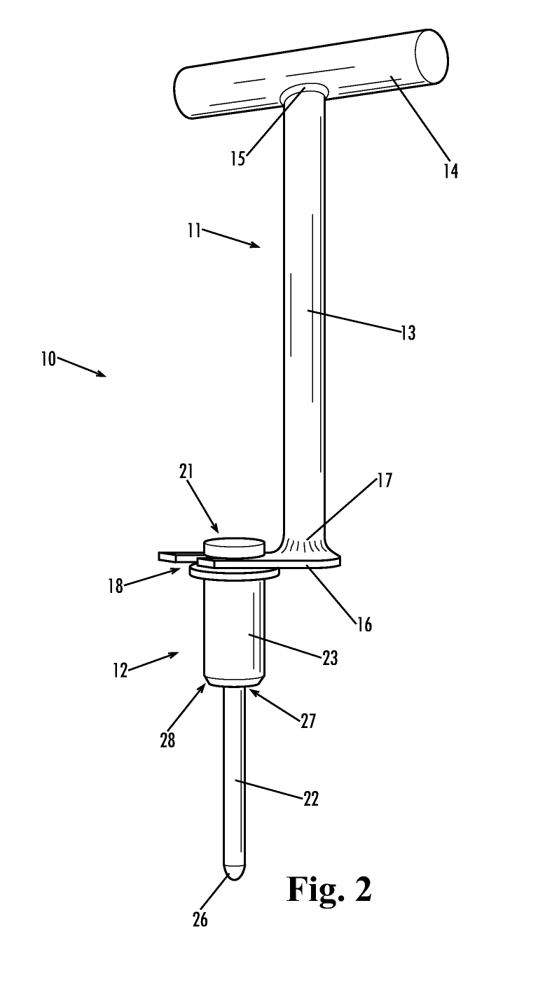

As shown in FIG. 2, the present invention comprises a combination 10 of a lifting tool or extracting tool 11 and a locating pin 12. The extraction tool 11 is generally in the form of a T-handle including a long shaft 13 having a handle or handgrip 14 affixed thereto. The handgrip in the shaft can be made of tubular materials or solid materials as desired. In one preferred form, these components are made of solid metal and are welded to one another at weld 16. The handgrip portion can be as little as a few inches across, while is expected that in a typical application the shaft would be several inches long. At the bottom of the shaft 13, a crow's foot 16 is permanently attached to the shaft 13, such as by a weld 17. The crow's foot can be made of sheet material, such as from ⅛″ thick steel. Of course those skilled in the art will recognize that various materials and dimensions can be employed, as desired. The crow's foot 16 includes a U-shaped opening indicated only generally in this figure at 18.

The U-shaped opening is adapted to closely receive a head portion or button 21 therein. The locating pin 12 comprises three main portions. Those portions include a slender pin portion 22, a cylindrical dowel portion 23 and the aforementioned head portion 21. The slender pin portion 22 can be made in various lengths and diameters. Inventor has found that one suitable diameter of the pin portion 22 can be 0.18 inches. Of course, this is merely an example, as the diameter of the slender pin portion should be sized to match the locating holes formed in the work pieces or jigs or fixtures with which the locating pin is to be used.

At the distal end of the slender pin portion 22, the pin portion 22 terminates in a smoothly radiused tip 26. While the tip 26 could be chamfered or otherwise eased, it is preferred that the tip be rounded or radiused to minimize the likelihood of scratching any portion of any work piece that the locating pin comes in contact with, while at the same time providing good ease of insertion into a locating hole. At the proximal end 27 of the slender pin portion 22, the slender pin portion 22 is attached to and extends from the dowel portion 23 of the locating pin 12. Adjacent this lower portion of the dowel portion 23, the dowel portion 23 includes a chamfered or radiused lower edge indicated generally at 28. This chamfered or radiused edge 28 helps to each of the dowel portions into its corresponding hole in any jig or fixture.

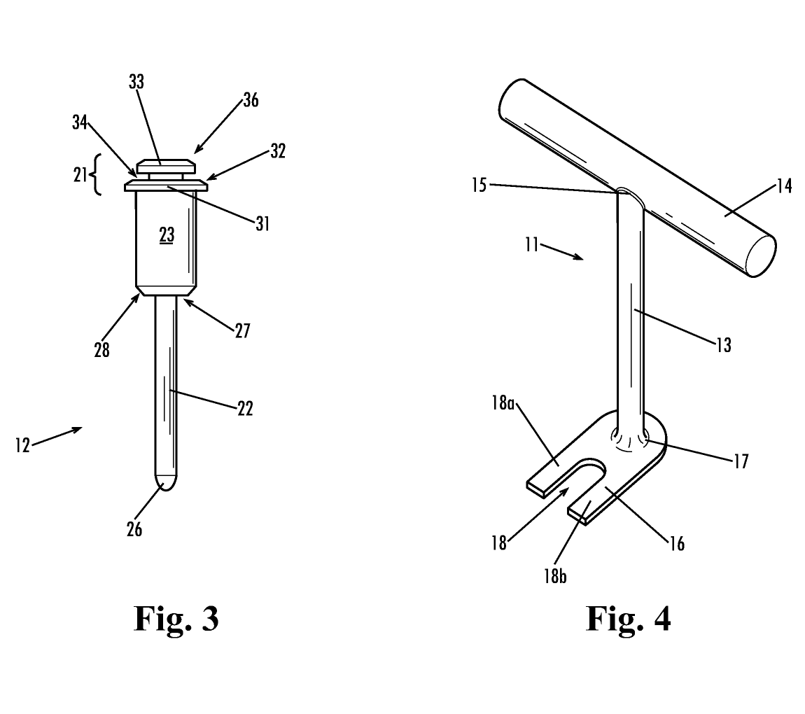

As shown in FIG. 3, a flange 31 extends slightly transversely from the top edge of the dowel portion 23. An upper, outer edge of the flange 31 is provided with a chamfer indicated at 32. The chamfer tends to ease the U-shaped crow's foot into engagement with the head of the locating pin 12. The head portion 21 of the locating pin also includes a button 33 spaced above the flange 31 and defining a circumferential groove indicated generally at 34. The circumferential groove 34 comprises a space into which the U-shaped crow's foot 16 is received. Like the flange 31, the button 33 includes a chamfered upper outer edge indicated at 36.

FIG. 4 shows the extraction tool 11, including the handgrip portion 14 attached to the shaft 13 at a weld 16. FIG. 4 also shows the crow's foot 16, which is welded to the shaft 13 at weld 17. As shown, the crow's foot 16 is generally U-shaped at one end and defines a U-shaped opening indicated generally at 18 for engaging the circumferential groove 34 in the locating pin 12. A pair of arms 18a and 18b extend away from the shaft 13 and define the U-shaped opening 18. The arms 18a and 18b are slipped into the circumferential groove 34 for lifting the locating pin.

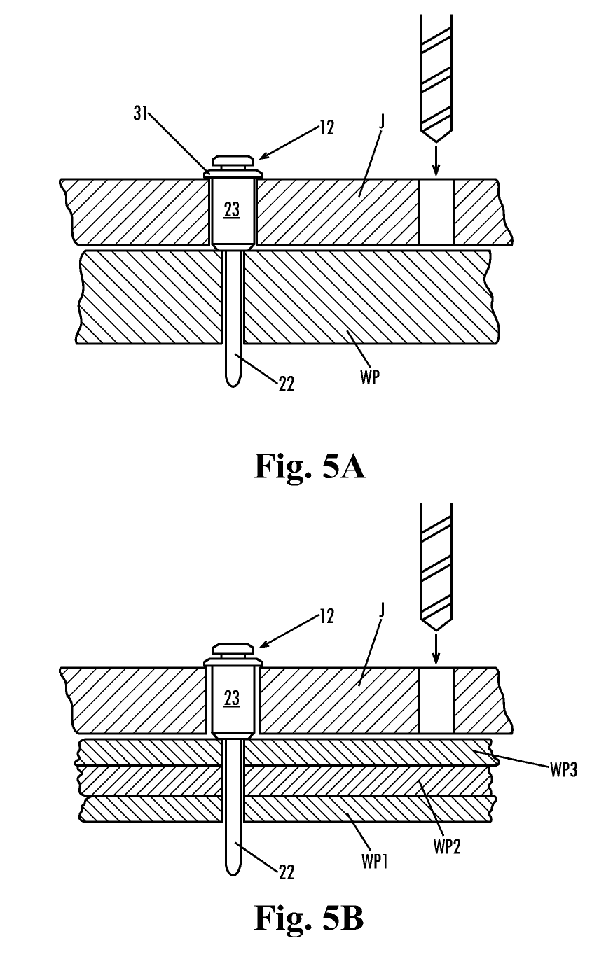

FIG. 5A shows the locating pin 12 according to the first preferred form of the invention and inserted into a jig J and into and through a work piece WP. Those skilled in the art will recognize that the locating pin according to the present invention has ready application for securing and/or locating a work piece relative to a jig, relative to a fixture, or relative to another work piece. Also, it shall be understood that the term “jig” as used in the claims appended hereto refers to both jigs and fixtures.

As can be seen in FIG. 5A, the locating pin 12 maintains a low profile and protrudes above the upper surface of the jig J but a little, thereby providing excellent clearance for machining operations. As depicted in FIG. 5A, one such machining operation is drilling. As shown herein, the upper flange 31 can act to limit travel of the locating pin 12 into the jig J. In addition, the lower portion of the dowel portion 23 can provide a similar movement-limiting function in that the dowel portion 23 has a larger diameter than the slender pin portion 22 such that there are guide holes into which the slender pin portion 22 can be received, while the dowel portion 23 is prevented from traveling therein. Thus, as depicted in this illustrative example shown in FIG. 5A, even in the absence of the flange 31, the dowel portion 23 would prevent further downward motion of the locating pin 12 with jigs and work pieces configured similar to that as shown.

FIG. 5B shows the locating pin 12 according to the first preferred form of the invention and inserted into a jig J and into and through three work pieces WP1, WP2, and WP3. Similar to the depiction in FIG. 5A, as shown in FIG. 5B, the upper flange 31 can act to limit travel of the locating pin 12 into the jig J. In addition, the lower portion of the dowel portion 23 can provide a similar movement-limiting function in that the dowel portion 23 has a larger diameter than the slender pin portion 22 such that there are guide holes into which the slender pin portion 22 can be received, while the dowel portion 23 is prevented from traveling therein. Moreover, as depicted in this figure, the slender pin portion 22 of the locating pin 12 is acting to closely locate the three work pieces relative to one another. In this regard, the hole into which the dowel portion 23 is received is materially larger than the dowel portion to provide enough clearance so that the dowel portion is not closely guided therein.

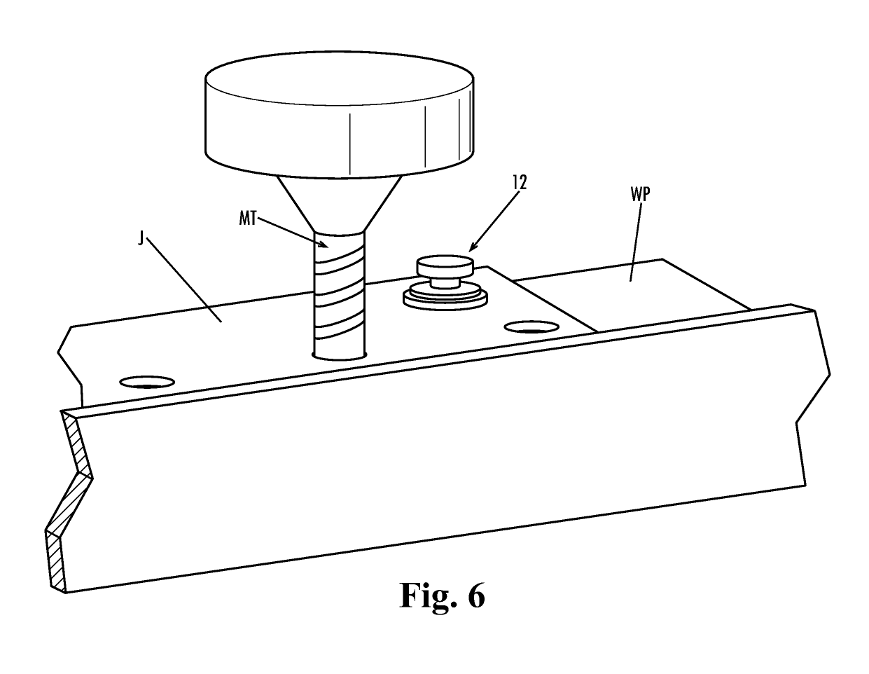

FIG. 6 shows in perspective a locating pin 12 inserted through the jig J in into the work piece WP for positioning and securing the work piece relative to the jig to allow the work piece to be precision machined by the machine tool MT.

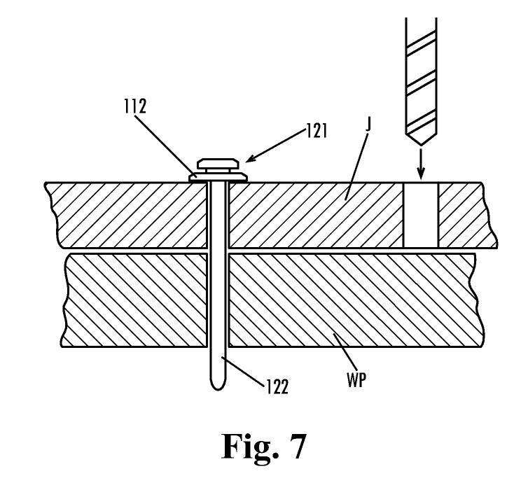

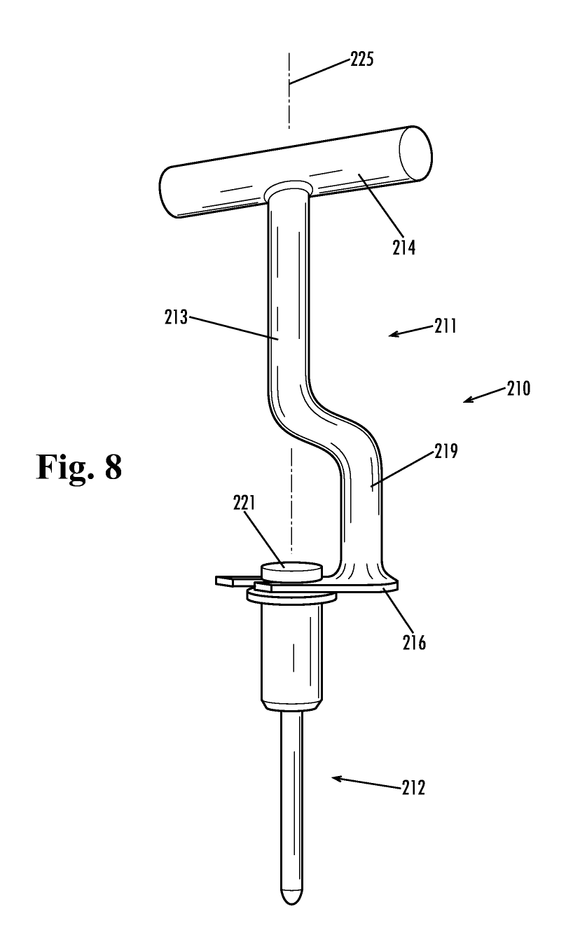

FIG. 7 shows a locating pin 112 according to another form of the invention and shown inserted through a jig J and into a work piece WP for facilitating a machining operation. The locating pin 112 includes a slender pin portion 122 and a head portion 121. The head portion 121 is similar to the head portion 21 of the locating pin 12 of the earlier figures. However, locating pin 112 of this embodiment does not include a larger diameter dowel portion. Instead, the slender pin portion 122 extends all the way to the head portion 121.

FIG. 8 is a perspective illustration of a locating pin and extraction tool combination 210 according to another preferred form of the invention. In combination 210 includes an extraction tool indicated generally at 211 and a locating pin indicated generally at 212. The locating pin 212 is identical to the locating pin 12 of FIGS. 2-6 and need not be described further herein. Notably, the extraction tool 211 differs from the earlier depicted extraction tools herein in that the extraction tool 211 includes a handle 213 having a lower offset portion 219. The crow's foot 216 attached to the offset portion 219 is thereby positioned such that the head 221 of the locating pin 212 is aligned with the axis of elongation 225 of the upper portion of the shaft 213. In this way, when one pulls upwardly on the handgrip portion 214, the force on the locating pin 212 is straight up through the handle, thereby providing a more effective extraction device. This can be helpful when a locating pin is stuck in its locating hole for some reason.

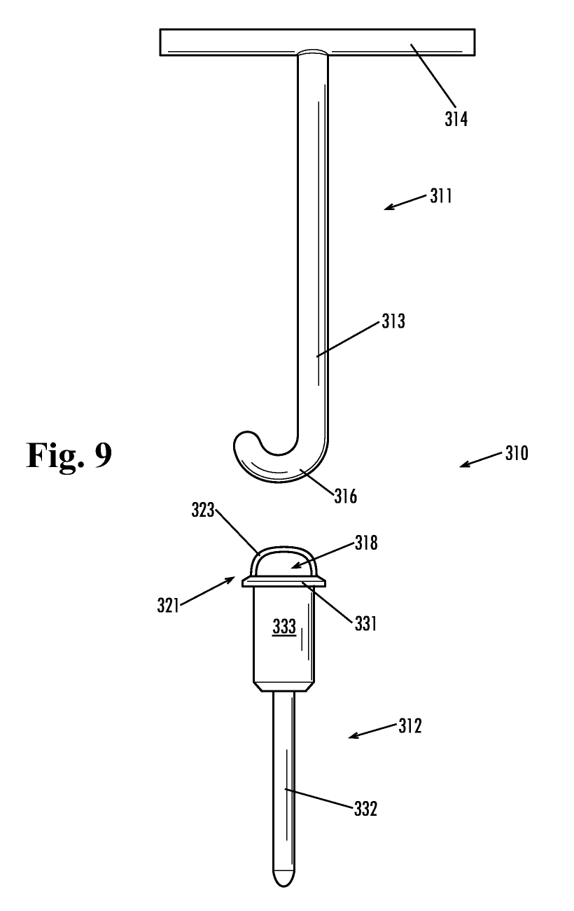

FIG. 9 is an elevation view of a locating pin and extraction tool combination 310 according to another preferred form of the invention. In this embodiment of the invention, the combination 310 includes an extraction tool 311 having a handgrip portion 314 and J-shaped or hook-shaped lifting shaft 313. The J-shaped lifting shaft 313 includes a lower hook 316 which is sized and adapted to be slipped into an opening 318 formed by a loop 323 attached to or formed in a head portion 321 of a locating pin 312. The head portion 321 also includes a beveled flange 331, a dowel portion 333, and a slender pin portion 332.

While the invention has been described with reference to preferred and example embodiments, it will be understood by those skilled in the art that a variety of modifications, additions and deletions are within the scope of the invention, as defined by the following claims.

What is claimed is:

1. In combination, a locating pin and extraction tool for locating a work piece in conjunction with a jig, the combination comprising:
a locating pin including an elongate body having a head portion and a lower pin portion, the elongate body being of a length which is substantially greater than it is wide, and wherein the pin portion is adapted to be inserted through a locating hole in the jig and into a locating hole in the work piece to locate the work piece, and wherein the head portion is a low-profile head, and wherein the head has a height and width both of which are much smaller than the length of the elongate body; and
a lifting tool having a handle and a lifting foot adapted to engage the head portion of the locating pin for lifting and extracting the locating pin.

2. The combination as claimed in claim 1 wherein the locating pin further comprises a dowel portion extending between the pin portion and the head portion, and wherein the dowel portion has a width which is greater than the width of the pin portion.

3. The combination as claimed in claim 2 wherein the dowel portion is substantially cylindrical and has a tapered lower edge to facilitate insertion and alignment.

4. The combination as claimed in claim 2 wherein the head portion comprises a flange that extends transversely beyond an edge of the dowel portion to limit insertion travel of the locating pin.

5. The combination as claimed in claim 1 wherein the lifting tool comprises a T-handle.

6. The combination as claimed in claim 1 wherein the lifting tool comprises a crow's foot-shaped lifting foot.

7. The combination as claimed in claim 1 wherein the locating pin comprises a groove formed in the side of the low-profile head and the lifting foot comprises a U-shaped foot for slipping into and engaging the groove formed in the low-profile head.

8. The combination as claimed in claim 1 wherein the locating pin comprises a loop and the lifting foot comprises a hook for slipping into and engaging the loop in the low-profile head.

9. The combination as claimed in claim 1 wherein the locating pin comprises a generally rounded distal end.

10. The combination as claimed in claim 1 wherein the lifting tool includes an offset portion to align the lifting foot with the handle.

11. A locating pin for use with an extraction tool for locating a work piece in conjunction with a jig, the locating pin comprising:
an elongate body having a head portion and a lower pin portion, the elongate body being of a length which is substantially greater than it is wide, and wherein the lower pin portion is adapted to be inserted through a locating hole in the jig and into a locating hole in the work piece to locate the work piece, and wherein the head portion is a low-profile head, and wherein the head has a height and width both of which are much smaller than the length of the elongate body.

12. The locating pin as claimed in claim 11 further comprising a dowel portion extending between the pin portion and the head portion, and wherein the dowel portion has a width which is greater than the width of the lower pin portion.

13. The locating pin as claimed in claim 12 wherein the dowel portion is substantially cylindrical and has a tapered lower edge to facilitate insertion and alignment.

14. The locating pin as claimed in claim 12 wherein the head portion comprises a flange that extends transversely beyond an edge of the dowel portion to limit insertion travel of the locating pin.

15. The locating pin as claimed in claim 11 wherein the head portion comprises a groove formed in the side of the low profile head for receiving a lifting tool therein.

16. The locating pin as claimed in claim 11 wherein the head portion comprises a loop formed in the low profile head for receiving a lifting tool therein.

17. The locating pin as claimed in claim 11 wherein the locating pin comprises a generally rounded distal end.

18. An extraction tool for use with a locating pin having a head portion and adapted for locating a work piece in conjunction with a jig, the extraction tool comprising:
a lifting tool having a handle and a lifting foot adapted to engage the head portion of the locating pin for lifting and extracting the locating pin.

19. The extraction tool as claimed in claim 18 wherein the lifting tool comprises a T-handle.

20. The extraction tool as claimed in claim 18 wherein the lifting tool comprises a crow's foot-shaped lifting foot.

21. The extraction tool as claimed in claim 18 wherein the lifting foot comprises a U-shaped foot for slipping into and engaging a groove formed in the low-profile head.

22. The extraction tool as claimed in claim 18 wherein the lifting foot comprises a J-shaped hook for slipping into and engaging a loop in the low-profile head.
